(19) United States
(12) Patent Application Publication
(10) Pub. No.: US 2005/0288083 A1
(43) Pub. Date: Dec. 29, 2005

(54) Distributed intelligent data collection system for casino table games

(75) Inventor: Justin Gaylord Downs III, Henderson, NV (US)

Correspondence Address: Mark A. Litman & Associates, P.A.;York Business Center, Suite 205, 3209 West 76th Street, Edina, MN, 55435, US

(73) Assignee: Shuffle Master, Inc.

(21) Appl. No.: 10/880,408

(22) Filed: Jun. 28, 2004

(51) Int. Cl. G06F 17/00; G06F 19/00

(52) U.S. Cl. 463/11

(57) ABSTRACT

A gaming table with multiple sensing devices on or proximate the table. Each sensing device or groups of devices has a separate intelligent module that senses changes in the sensing devices. The module date stamps and transmits the data over a network to an external database.

### BACKGROUND OF THE INVENTION

1. Field of the Invention

The present invention relates to the field of gaming systems, particularly to table gaming systems that have elements of play, reward, monetary/credit transactions and/or monitoring that are performed by processing systems, and particularly including casino table games and casino table card games.

2. Background of the Art

Wagering games, such as those played in casinos and card clubs, have traditionally been played with only live casino personnel (dealers, croupiers, etc.) and mechanical implements such as cards, dice, chips, jettons, markers, wheels, balls and the like. One of the reasons for this is to make the entire wagering game open for inspection, including the players, the casino personnel and the implements that are used to provide the chance occurrences upon which the wagers are made.

The creative mind of players and wagering institutions have devised ways of manipulating implements or calculating probabilities of events that have affected the odds in the favor of the manipulator. Cards have been marked, ‘sleeved’ for timed use, stacked in a deal, bottom dealt, or otherwise altered in characteristics or location to enable cheating. Sophisticated players are able to read decks by counting cards, and have been able to calculate changes in the probability of success at different times in the game of blackjack in particular, altering overall odds more in favor of the player. The use of limited portions of decks, efficient card shuffling devices, restrictions on players' handling of cards, and continuous shuffling devices have alleviated some of the card problems.

Dice have been weighted or counterfeited to influence the occurrence of specific values, chips have been switched or amounts altered on the tables in craps. This has been addressed by the presence of many persons in the pit crew that supervise elements of the game and the close surveillance of activities on the table by proximal personnel at the table or distal personnel watching cameras or tapes of activities.

Processing equipment and computers have become an increasingly important part of the gaming industry, but the introduction of the technology has been sporadic, inconsistent, and often ill designed. In addition, the direction of improvement in the processing apparatus used in casinos has consistently been heading in the direction that bigger and more powerful is better, attempting to mimic the home computer market trends. The original processors introduced into the market were hardwired, unique designs that performed all command functions from a central controlling processor or actually performed within a single computer that sent signals to all mechanical operating elements.

Traditional gaming devices such as slot machines, for example are based around a simple processor unit including a random number generator, an accounting means operatively coupled to a static/battery backed random access memory, and a set of EPROM's and PROMS having stored therein the important gaming functions. In addition, these gaming devices include gaming displays, coin acceptors, bill validators and hoppers, all operatively coupled to the same processor. These gaming devices are relatively simple and are limited in scope, usually consisting of a single executing program utilizing straightforward interrupt schemes and detection loops for asynchronous events for simple evaluation. It is also a simple matter of operatively coupling an external program validation device to an EPROM chip for providing effective regulatory validation of critical gaming functions to preclude unauthorized tampering or modification of the gaming machine through software. In addition, an external device validation process for suspicious jackpots or disputes may be validated by simply reading the static/battery backed random access memory associated with the simple processor. Furthermore, software developers in the gaming industry are hesitant to include compromising code in traditional gaming devices due to the ease of both internal and regulatory review.

One important trend in today's gaming devices is towards an increasing utilization of personal computer based gaming platforms. Personal computer based platforms are being employed by designers to make use of real time operating systems which allow for multi-threaded/multi-tasking processes and the use of many “off the shelf” hardware and software components. While at first, this may seem an advantage at least from a manufacturing standpoint, it creates design obstacles in an environment requiring high security and regulatory monitoring. Designs of this nature elude validation by regulatory authorities in two areas, initial laboratory evaluation and field validation.

There are a wide variety of associated devices that can be connected to or serve as part of a gaming machine such as a slot machine. These devices provide gaming features that define or augment the game(s) played on the gaming machine. Some examples of these devices are slot reels, lights, ticket printers, card readers, speakers, bill validators, coin acceptors, display panels, keypads, and button pads. Many of these devices are built into the gaming machine. Often, a number of devices are grouped together in a separate box that is placed on top of the gaming machine. Devices of this type are commonly called a top box.

Published U.S. Patent Application Serial No. 2002/0107067 A1 (McGlone et al.) provides a slot reel peripheral having a slot reel, a drive mechanism and a peripheral controller. Using a standard communication protocol such as USB (Universal Serial Bus), the peripheral controller is configured to communicate with one or more master gaming controllers or other slot reel peripherals via a peripheral connection. The peripheral controller may drive the slot reel from position to position by operating the drive mechanism and may send operating instructions to other slot reel peripherals with peripheral controllers. Further, the peripheral controller may control one or more specialized “peripheral devices” (e.g., effects lights, back lights, bar code detectors, tampering sensors, position sensors, sound devices, electro-luminescent devices and stepper motors, etc. that perform specific functions of the slot reel peripheral).

One aspect that McGlone provides is a slot reel peripheral that generally can be characterized as including (1) a drive mechanism, (2) a single slot reel that may be moved from position to position by the drive mechanism, (3) a peripheral controller that directly controls the drive mechanism and (4) a peripheral communication connection for connecting the peripheral controller to a master gaming controller.

Similarly, Published U.S. Patent Application 2001/0036866 (Syckdale et al.) describes a gaming machine comprising: a master gaming controller that controls one or more games played on the gaming machine; and a plurality of gaming peripherals coupled to the gaming machine and in communication with the master gaming controller, each of the plurality of gaming peripherals comprising a standard peripheral communications connection, one or more peripheral devices specific to each gaming peripheral, and a peripheral controller designed or configured to control the one or more peripheral devices, the peripheral controller including (i) a control microprocessor, separate from the master gaming controller, designed or configured to control communication with the master gaming controller over the peripheral connection, and (ii) a peripheral interface that directly connects to the one or more peripheral devices and is specific to the individual gaming peripheral.

The peripheral controller preferably includes (i) a control microprocessor that controls communication with the master gaming controller over the peripheral connection (the controller microprocessor is substantially similar in each gaming peripheral), and (ii) a peripheral interface that directly connects to one or more peripheral devices and is specific to the individual gaming peripheral.

In one embodiment, the gaming machine includes a motherboard with an acceptor for the master gaming controller and a hub containing a plurality of standard communications ports for connecting to the plurality of gaming peripherals. The acceptor is configured to allow the master gaming controller to be removed from the motherboard without requiring disconnection of the gaming peripherals from the hub. Further, the motherboard is configured to allow additional gaming peripherals to be connected to the master gaming controller without requiring that the motherboard be rewired. In preferred embodiments, the gaming machine is a mechanical slot machine, a video slot machine, a keno game, a lottery game, or a video poker game. One or more of the peripheral devices may be selected from the group consisting of lights, printers, coin hoppers, bill validators, ticket readers, card readers, key pads, button panels, display screens, speakers, information panels, motors, mass storage devices and solenoids. At least one of the standard communications ports may be a secure port, having a level of security exceeding that of other ports on the hub. The secure port is secured by one or more doors, locks, sensors, evidence tapes, or combinations thereof. Further, the master gaming controller may be configured to require that a specified gaming peripheral be connected only through the secure port. Also, the gaming machine may include a plurality of hubs, each containing a plurality of standard communications ports for connecting to the plurality of gaming peripherals, where one or more of the hubs is a secure hub, having a level of security exceeding that of one or more other hubs. The secure hub is secured by one or more doors, locks, sensors, evidence tapes, or combinations thereof. Further, the master gaming controller is configured to require that specified gaming peripherals be connected only through secure hubs.

Published U.S. Patent Application 2001/0187830 (Stockdale et al.) describes a gaming machine that generally can be characterized as including (1) a master gaming controller that controls one or more games played on the gaming machine, and (2) a plurality of gaming peripherals coupled to the gaming machine and in communication with the master gaming controller. The gaming peripheral should include (a) a standard peripheral communications connection, which may be identical in each gaming peripheral (b) one or more peripheral devices specific to the individual gaming peripheral and (c) a peripheral controller that controls the one or more peripheral devices. The peripheral controller preferably includes (i) a control microprocessor that controls communication with the master gaming controller over the peripheral connection (the controller microprocessor is substantially similar in each gaming peripheral), and (ii) a peripheral interface that directly connects to one or more peripheral devices and is specific to the individual gaming peripheral. In one embodiment, the gaming machine includes a motherboard with an acceptor for the master gaming controller and a hub containing a plurality of standard communications ports for connecting to the plurality of gaming peripherals. The acceptor is configured to allow the master gaming controller to be removed from the motherboard without requiring disconnection of the gaming peripherals from the hub. Further, the motherboard is configured to allow additional gaming peripherals to be connected to the master gaming controller without requiring that the motherboard be rewired.

U.S. Pat. No. 6,071,190 (Weiss) describes a gaming device security system which includes two processing areas linked together and communicating critical gaming functions via a security protocol wherein each transmitted gaming function includes a specific encrypted signature to be decoded and validated before being processed by either processing area. The two processing areas include a first processing area having a dynamic RAM and an open architecture design which is expandable without interfering or accessing critical gaming functions and a second “secure” processing area having a non-alterable memory for the storage of critical gaming functions therein.

Typically, on a live gaming table, a central gaming machine computer controls various combinations of devices. The features of a given device, including card reading, game status detection and the like are usually controlled by a “master gaming controller” in communication with the casino table gaming table monitoring equipment. For example to control payouts during a game, the master gaming controller might perform many different operations including electronically comparing player hands with a pre-programmed pay table of winning combinations and payouts, confirming that a side wager was made prior to paying out a side bet payout to a player, instructing a stepper motor on a card delivery system to access cards within the device, deliver cards to the dealer and then stop card movement/delivery at a certain position, verify that the correct number of cards are present in the shuffler, instructing lights on the table reel to go on and off in various patterns, or instructing a speaker connected to the table to emit various sound patterns, for example. For the master gaming controller to perform these operations, connections from the casino table are wired directly into some type of electronic board (e.g., a “back plane” or “mother board”) containing the master gaming controller.

Casino Table Games (such as blackjack, poker, poker variants such as Let It Ride® poker, Three Card™ poker and Four-Card™ poker, baccarat, Casino War™ game, also require some security control, and more highly automated systems are being described in the literature and introduced to the marketplace. There are, for example, numerous U.S. Patents assigned to MindPlay LLC (e.g., U.S. Pat. Nos. 6,712,696; 6,688,979; 6,685,568; 6,663,490; 6,652,379; 6,638,161; 6,595,857; 6,579,181; 6,579,180; 6,533,662; 6,530,837; 6,530,836; 6,527,271; 6,520,857; 6,517,436; 6,517,435; and 6,460,848) that describe systems and components of systems that are used to more fully automate casino table card games, and especially blackjack. These systems include card recognition devices, bet sensing devices (e.g., chip sensors and counters), software to evaluate the games as and after they are played, and the like. One feature of the MindPlay system is a central processor.

U.S. Pat. No. 5,803,808 (Strisower) describes a device to be utilized in live casino gaming that will count the number of “hands” (read “rounds”) of a given card game played per given period of time. The information is used by a database system within the casino to determine theoretical win/loss based upon historical and theoretical outcome data related to probability of winning/losing any given hand and then factoring in the number of hands (rounds) played. Preferably this device is polled by a database system to collect this information. In a preferred embodiment, the device could be utilized with an automatic tracking and information management system. The automatic tracking and information management system (ATMS) automatically determines various player transactions associated with a device in a gaming establishment. The ATMS includes an automatic tracking and management unit (ATMU) which transmits and receives information between all gaming tables in all pit areas and the gaming establishment database system.

The ATMU provides for the interactive determination of various transactions within the pit area. Through the automatic tracking and management system the manual paper tracking, activities associated with the pit area are eliminated, thereby freeing pit personnel for other tasks. The device could also be generically connected to any tracking and information system through any standard serial interface.

Various other U.S. Patents that include automation enhancing technology for casino table card games include U.S. Pat. Nos. 6,582,301; 6,299,536; 6,165,069; 6,117,012; 6,093,103; 6,039,650; 5,722,893; 5,605,334. As can be seen from these disclosures, the computing structural and component structures of gaming systems follows the traditional format of a main processor driving peripherals, and where one feature demands a significant amount of computing power, two processors may be added, with one processor still tending to be the dominant main processor sending commands to the peripherals. In proposed table systems, peripheral devices (such as a hand sensor or round counter or bet sensor provides the signal and sends the signal to the gaming table processor and/or to a main processor. These signals are sometimes logged in with a time stamp for noting when it was received and/or logged in. The systems in gaming table operations tend to be structured in the same manner, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game. Examples of such systems include method, apparatus and article for verifying card games, such as playing card distribution as described in U.S. Pat. Nos. 6,638,161; 6,595,857; 6,5,79,181; 6,579,180; 6,533,275; 6,530,837; 6,530,836; 6,527,271; 6,520,857; 6,517,436; 6,517,535; and 6,460,848 (the Soltys' patents). Other gaming table systems that operate on the basis of a central programmer commanding peripheral devices (that may or may not have some processing capability of their own) include U.S. Pat. Nos. 6,299,536 and 6,039,650 (Hill); U.S. Pat. No. 5,779,546 (Meissner) which describes touch screens and player entry features at each player position, U.S. Pat. Nos. 6,093,103 and 6,117,012 (McCrea) which describes card sensing systems at each player location as well a card reading shoes; and U.S. Pat. No. 6,126,166 (Lorson) describing a card control and recognition system and method. U.S. Pat. No. 6,629,894 (Purton, Dolphin Advanced Technologies, Ltd.) describes a card inspection device including a first loading area adapted to receive one or more decks of playing cards.

A drive roller is located adjacent the loading area and positioned to impinge on a card if a card were present in the loading area. The loading area has an exit through which cards are urged, one at a time, by a feed roller. A transport path extends from the loading area exit to a card accumulation area. The transport path is further defined by two pairs of transport rollers, one roller of each pair above the transport path and one roller of each pair below the transport path. A camera is located between the two pairs of transport rollers, and a processor governs the operation of a digital camera and the rollers. A printer produces a record of the device's operation based on an output of the processor, and a portion of the transport path is illuminated by one or more blue LEDs. A printer is also provided as part of the system driven by a central computer.

Crown Casinos in Australia has recently provided a device that assists in counting rounds of play by using a card-sensing component on a table that responds to the blockage of ambient light into a hole and the forwarding of the sensed data to a central computer. The data is logged in as it is received to indicate a time element associated with each piece of data received.

Traditionally, the master gaming controller has performed all game functions including the calculation of the game outcome, coin handling, communications with external devices, lighting control, operation of the slot reels, etc. for the slot machine. As the slot machine has evolved, the features offered to players have become more complex and the potential combinations of gaming devices available to a gaming machine has increased. For example, video animations, combined with digital audio have been added to the basic game play of the spinning reel slot machine. To execute these complex game features and perform all of the game functions, a microprocessor with significant computational capabilities is required. Further, to accommodate all of the gaming devices within the gaming machine, the motherboard containing the microprocessor must have the necessary circuitry and wiring needed to communicate with the all of the devices operated by the master gaming controller.

In the past, instead of designing one motherboard that could accommodate communications with all of the potential gaming devices, a number of different motherboards were designed, each accommodating communications with some subset of the available gaming devices.

Disadvantages of the current casino table games architecture include at least the following. First, the number of types of motherboards needed to accommodate all of the potential combinations of gaming devices has become large. Second, the computational capability of the motherboard needed to drive all the devices has become large. Third, when devices are added to augment the features of the gaming machine or when devices are replaced for maintenance the steps necessary to rewire the device onto the motherboard and load the appropriate software onto the motherboard can be time consuming and require significant shutdown time for the gaming table. Accordingly, it would be desirable to provide casino gaming table architecture and components that are compatible with a standard communication protocol and/or connection system for installing or removing devices controlled by a local, central or other master gaming controller.

A casino table gaming peripheral that is compatible with a standard communication protocol and/or connection system may reduce the number of types and sophistication (expense) of motherboards that are needed for the casino table gaming machine and may reduce the amount of maintenance time when any electronic component is replaced. Further, it would be desirable to have the casino table gaming peripheral control some of its own functions rather than having all the functions controlled by the master gaming controller. This feature might reduce the load on the computational resources of the master gaming controller.

A concept of operative control among processing units should be appreciated to appreciate the performance of the present invention as well as to comprehend differences between the practice of the present invention and conventional processing apparatus used in the gaming industry. The most important concept is that all existing systems perform by a single main processor sending commands to peripherals to perform specific functions. For purposes of discussion, the initial main emphasis of the description will be directed towards the performance of a casino table card game gaming apparatus. This emphasis is not intended to narrow the scope of the invention, but is rather intended to simplify the description.

In a standard slot-type gaming apparatus, different events are sensed and provide information. The central processor evaluates this information and commands another element to perform a procedure or initiate a sequential event. For example, a coin is deposited in the coin receptor, the coin is sensed in the coin acceptor and a signal is sent to the main process or that a coin has been received. The main processor receives this information and sends a signal to the credit display to indicate that one credit should be displayed. An additional signal is sent to the button rack that activates the game initiation (Start) button that enables a player to press the Start button to enable a game to begin. Prior to this command from the main processor, the Start button was inactive. When a second coin is inserted, the same event happens between the coin acceptor, the processor and the credit display, with the command now being to display two available credits. The processor knows not to send a separate activation notice to the Start button. When the player presses the credit use button (e.g., Bet Maximum Credits, Bet One Credit, etc.), a signal is sent to the game control function within the main processor to register the amount of the wager. The main processor then demands that the video display show the number of credits wagered. When the Start button is pressed, a signal is sent to the main processor that then sends a signal to the game processor to initiate play of a game. Signals are sent from the main processor to the video screen and the random number generator to perform the tasks necessary to effect a play event. The random number generator provides the results to or within the main processor and the main processor identifies the symbols to be displayed on the video screen and determine the existence of the status of the wager (win, lose or draw). In the event that the processor determines that a winning event has occurred, the processor then signals the credit display to indicate the total amount of credits won and commands the screen to display any winning alerts and the like. As can be seen from this analysis, the individual peripherals send signals to the main processor and the main processor provides specific commands to the various peripherals that specific functions are to be performed. There are a couple of concepts that are important to consider in this performance. First, a fairly sophisticated and powerful processor is needed to control all of the peripherals, such as a PC grade processor. Second, the processor must order events to send out separate signals to each of the peripherals, slowing down game performance. As can be seen from these disclosures, the computing structural and component structures of gaming systems follows the traditional format of a main processor driving peripherals, and where one feature demands a significant amount of computing power, more processors may be added, with one still tending to be the dominant main processor sending commands to the peripherals.

The systems in live gaming table systems tend to be structured in the same manner as the slave master-formats of slot machine devices, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game.

Examples of such systems include method, apparatus and article for verifying card games, such as playing card distribution as described in U.S. Pat. Nos. 6,638,161; 6,595,857; 6,5,79,181; 6,579,180; 6,533,275; 6,530,837; 6,530,836; 6,527,271; 6,520,857; 6,517,436; 6,517,535; and 6,460,848 (the Soltys' patents). Other gaming table systems that operate on the basis of a central programmer commanding peripheral devices (that may or may not have some processing capability of their own) include U.S. Pat. Nos. 6,299,536 and 6,039,650 (Hill); U.S. Pat. No. 5,779,546 (Meissner) which describes touch screens and player entry features at each player position, U.S. Pat. Nos. 6,093,103 and 6,117,012 (McCrea) which describes card sensing systems at each player location as well a card reading shoes; and U.S. Pat. No. 6,126,166 (Lorson) describing a card control and recognition system and method. U.S. Pat. No. 6,629,894 (Purton, Dolphin Advanced Technologies, Ltd.) describes a card inspection device including a first loading area adapted to receive one or more decks of playing cards. A drive roller is located adjacent the loading area and positioned to impinge on a card if a card were present in the loading area. The loading area has an exit through which cards are urged, one at a time, by a feed roller. A transport path extends from the loading area exit to a card accumulation area. The transport path is further defined by two pairs of transport rollers, one roller of each pair above the transport path and one roller of each pair below the transport path. A camera is located between the two pairs of transport rollers, and a processor governs the operation of a digital camera and the rollers. A printer produces a record of the device's operation based on an output of the processor, and a portion of the transport path is illuminated by one or more blue LED's. A printer is also provided as part of the system driven by a central computer.

As can be seen, even where there is some processing intelligence distributed around a gaming table, the underlying operation of the system remains a command and response structure, which both requires high component costs and limits the operation of the system. A gaming system with different architectural structure would be desirable if it could reduce costs and add flexibility to the system and enable ease of component replacement.

### SUMMARY OF THE INVENTION

Multiple intelligent data collection modules acting as a finite state machine is each communicatively interconnected with a sensing device to collect data, date stamp the data and send it to a central data repository via a network. The processing unit, referred to in this application as a “G-Mod” in one example of the invention is a microprocessor with associated memory that is capable of being programmed. In another form, the G-Mod is a hard wired as a FPGA (field programmable gated array). The G-Mod performs data acquisition, date stamps and sends sensed data via a network such as an Ethernet to an external computer that contains a database. In contrast to systems that provide an exclusive main computer to command all or most individual sensors and peripherals, in the presently described technology, the G-Mods detect activity in the sensors and peripherals. The G-Mods date stamp and broadcast the information over an Ethernet to a central database. One preferred mode of communication is UDP but others such as TCP and TCPIP are alternate communication protocols. In a preferred form of the invention, the G-Mods broadcast information over a network but do not cause other G-Mods to perform operations. Lowerless powerful techniques (as compared to typical main processor systems used in gaming apparatus) may be distributed to monitor each peripheral. The use of these separate intelligences for each peripheral eliminates the need to reprogram old modules as new modules are added, and allows the manufacturer to offer customized hardware and software packages capable of collecting only the information that the casino operator wants to collect.

Casino table card games can be provided with a wide variety of sensors. One such sensor is for detection of an indicator initiated by a dealer to indicate approximate beginner or final completion of a round of play of a casino table card game. The sensor is read by the distributed intelligence table subcomponent (a G-Mod) that has a time/dating capability. The signal is time/date stamped (referred to herein as “Date Stamping” or “date stamping” for simplicity. The date stamped data is then transmitted generally through a communication line to an external computer that contains database management software and a database interface. The data can be accessed by programs used to analyze the data, if needed. The database interface allows casino management to extract the data in a usable form. The collected data retains its date stamping at least through storage, analysis, data entry or other treatment of the data after transmission away from the table, and the date stamping is typically provided by the separate intelligence, although in some cases may or may not be provided by the sensor itself.

### BRIEF DESCRIPTION OF THE FIGURES

FIG. 1 shows a schematic of distributed architecture information flow in casino-type gaming machine.

FIG. 2 shows a flow diagram of distributed architecture information flow in a gaming table environment.

### DETAILED DESCRIPTION OF THE INVENTION

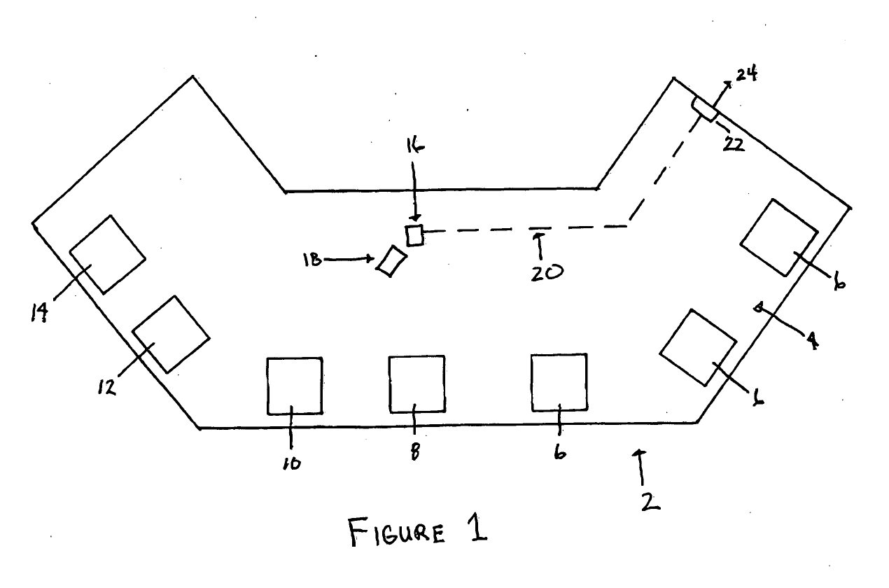

FIG. 1 shows a casino card gaming table 2. The table 2 has a surface 4 with seven player positions 6 (three positions labeled 6) 8, 10, 12 and 14 thereon. A hand sensor 16 is provided for the dealer cards 18. The sensor 16 is connected by a communication system (preferably a wire system, but RF or other wireless systems could be used) to a finite state machine 22 for the table 2. The finite state machine 22 is on a communication line 24 to a data collector (not shown).

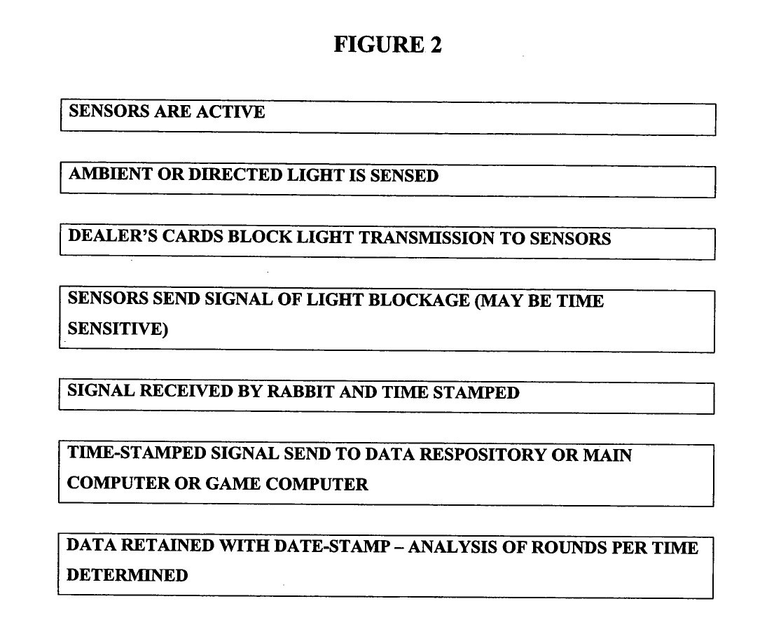

FIG. 2 shows a flow diagram of data transmission in the system of FIG. 1.

The components of a casino table gaming apparatus might include a coin acceptor, bill validator, a drop box capable of sensing the input of currency, ticket in/ticket out sensing/reading, lighting, video displays, card reading sensors, chip counters, security sensing, dealer input controls, player input controls, dealer identification card scanning, player tracking, round counting, hand counting, shuffle counting and the like. In the present technology described herein, a round counting system is also described, wherein the number of rounds of plays are determined (one round at a time) by a determination of when a dealer's play has been completed, as by complete removal of cards from the dealer's position.

In the practice of the present invention, communication to a data collection system with at least some peripherals is performed by general broadcast communication of game status (which may also be referred to as generated information or data) over a table-specific network, from more than one distributed intelligence source within the system, each of which is associated with at least one peripheral. Each distributed intelligence (a local processor) sends its own the game status communication over the network, but does not respond to game status information of other G-Mods. Each local processor (hereinafter G-Mod)) is capable of sending date stamped information to a database where the information is stored and can be accessed by the same computer that holds the database or by another external computer. This is a significant element in the practice of the invention, that information may be generally sent (essentially at the same time as a single, generally dispersed signal) over a network from multiple distributed intelligences.

For example, in the description given above for the insertion of a coin into the coin acceptor, when a coin is inserted in the system of the invention, the data is time stamped and send via an Ethernet network to a database collection system. As other G-Mod monitored activities occur, additional information is transmitted to the data collection system, independent of when/where other data is being collected and transmitted.

In one form of the invention, the state of each G-Mod is broadcast over a network that contains all of the sensors and G-Mods associated with one gaming table. As the state of each G-Mod changes, the signals being broadcasted to all of the G-Mods is changed, and each G-Mod independently transmits information to the central data collection point.

One conceptual way of visualizing or understanding a method of implementing an intelligence system for the operation of a gaming system according to the present invention is as decomposing the tasks of previous constrained (central processor commanded) systems into orthogonal or unrelated sensing events running on independent processors. The term “orthogonal” for purposes of this disclosure means no commonality in function. The provision of orthogonal or independent intelligence functionality and individual performance capability allows the various system components to operate independently, and timely transfer the date stamped data to a database for further processing. Such a system functions more efficiently because there is no central processor prioritizing the execution of functions.

As noted above, there are many different elements of the gaming system that can be considered as peripherals. Some more important examples of table-game related peripherals include: bet presence, bet recognition, bet separation, card identification, card tracking, player tracking and employee tracking. Other components might include (in addition to those described above) multimedia processing, stepper motor control, random number generation, I/O detection and response, audio signals, video signals, currency handling, coin acceptors, bill acceptors, paperless transactions, ticket-in and ticket-out crediting, security systems, player accounting functions, door locks, signal lighting (change/assistance), player input (e.g., button controls, joy sticks, touch screens, etc.) and any other functions that my be provided on the gaming apparatus.

The units (which may be elsewhere referred to herein as gaming modules or G-Mods) are operated substantially independently of each other, although some interdependencies could exist. In the event of interdependencies, they are not subject to the classic control model but operate by finite state machine changes that are broadcast and then react with intelligence. For purposes of this disclosure, the term “finite state machine” is a theoretical device used to describe the evolution of an object's condition based on its current state (or condition) and outside influences. The present state of an object, its history, and the forces acting upon it can be analyzed to determine the future state of an object. Each state then may have a “behavior” associated with it. An FSM is a very efficient way to model sequencing circuits. Ultimately the game is nothing more than a complex sequencing unit, branched as appropriate for the game function. All finite state machines can be implemented as hardware, software running on a processor or combinations of the two.

By assigning specific data collection controls to local architecture, the design of the system places system tasks into lower computing power manageable units. The manageable units (e.g., the peripherals) can then be each handled (or small groups handled) by dedicated controller modules. Some design care should be taken to combine control of peripherals under a single intelligence to assure that such accumulating demands for processing power are not being required as to merely reconstruct a main processor in a different physical location with the system. For example, it makes sense to combine the tower light (change/assistance) light command control intelligence with other button control signals, even though the result is not a game play function. The intelligence requirement for such an assistance function is so low that its addition to almost any other function would be barely noticed. In the distributed intelligence structure, the G-Modules or individual intelligences have enough intelligence on board to handle the details of how the G-Mod itself handles the details of operation of the peripheral device.

Although the present invention has been described largely in terms of a single round-counting module that sends date-stamped information to a central database, it is to be understood that multiple modules could be present in one system to send collected data to a data repository. In a preferred form of the invention, the data stamped data is broadcasted over an Ethernet specific to the table game, and that the data in this format is collected and recorded by the central data repository.

For example, a blackjack gaming table that is equipped with a round counting sensor and G-Mod may also be equipped with a sensor at the output of the dealing shoe for counting cards dispensed from the shoe. This information can be used in combination with the round counting information to deduce the number of cards dealt in a given round of play. If there are bet present sensors (and associated G-Mod(s)) for the bet sensors, the number of hands played per round of play can be determined. The modules may communicate with one-another to send date stamped bundles of information to the database, or may allow one module to influence the operation of another module.

Each G-mod is collecting, date stamping and transmitting data as the data is collected from the table to a central database, but the G-Mods are not influencing the operation of one another. The database does not issue commands to the G-Mods, except to reset, reboot and send and receive configuration information. In effect, each G-Mod is a freestanding microprocessor that runs independently of the any other intelligence, except that it receives limited operational information from the database computer.

A card swipe module could be added to the table system, with an associated G-Mod. This G-Mod could not only transmit time-stamped data to the data repository, but could also transmit player I.D. information to the player tracking system residing in the casino computer system.

One or more sensors could sense information transmitted through an output data port of a shuffler, for example, or a keypad control used to issue commands to a shuffler. The shuffler would have it's own G-Mod and is capable of transmitting date stamped information such as number of cards per hand, number of hands per hour, number of cards dispensed per unit time, number of cards re-fed into a continuous shuffler per unit of time, number of promotional cards dispensed per unit of time, etc. At the same time, another indicator attached to a G-Mod could transmit data stamped data about bonus awards granted at a certain time, and the like. This information could be collected in a central database.

A bet interface module could also be provided. Known collection techniques for wagering data include optical and metal detection type bet present sensors for fixed bets, and camera imaging, radio frequency/identification technology, bar code scanning, scene digitizing, laser scanning, magnetic strip reading and the like for measuring the amount of the bet, as well as the presence of the bet. Outputs from these measurement devices are fed through a dedicated G-Mod and the data is date stamped and delivered to the central data depository.

Another possible G-Mod controls a card reading camera or other sensing device with similar functionality (reading rank and suit of a card, or just rank) located in the card shuffler, the dealing shoe, the discard tray, above the table or combinations of the above. Information about the specific cards dealt to each player could be obtained from the database by first feeding date-stamped information about cards dealt and returned into the database via the Ethernet.

In one form of the invention, the G-Mod sends date-stamped information to the database and an algorithm residing in the same computer or separate computer uses this information as well as round counting and betting information to determine the composition of a hand of blackjack, for example.

Another G-Mod is in communication with an i.d. system for tracking the movement of employees in and out of the pit, or more preferably when the dealers arrive at and leave the table. This information is collected and reported by the dealer G-Mod into the database, and then reports can be generated that combine this information with rounds of play per hour to determine which dealers deal the most hands in a given period of time.

In a roulette application, a sensor and associated G-Mod can record the number of spins of the wheel in a unit of time, for example. This information could be associated with the player swipe card information from another G-Mod by merely comparing the time stamping of the data to determine how long a particular player stayed at a table.

It is important to note that in a preferred form of the invention, all of the G-Mod's are in communication with the same database. Also, data repository does not issue commands to the G-Mods, with the exception of requesting configuration data and resetting/rebooting the G-Mods. The central database merely organizes the data in a manner that allows for easy access by external computers or another application program residing on the same computer as the database. In this respect, the G-Mod's are self-executing and do not require central intelligence to perform their individual functions. The data may be analyzed and used to make decisions about awarding redeemable points and free rooms to players, etc., scheduling pit labor, promoting pit personnel, closing and opening tables, determining optimal betting limits for given periods of time and other important managerial functions.

Each G-Mod may be in data communication with an interface device such as one or more specialized circuit boards to allow the data from multiple G-Mod's to be fed into a standard port of the computer that serves as the data repository. Also, multiple sensing modules may be fed into a single G-Mod if the particular G-Mod has the capacity to process the extra information.

A software interface can be provided to directly access data in the data repository and to manipulate and organize the data so that it can be outputted onto a display, written report or formed into a data stream so that the data can be further manipulated. In one example of a software interface program, the operator can obtain reports of rounds of play per hour per actual table, per pit, or per property, as determined by the user.

The information in the form of a data stream may be further analyzed. In one example, the data is fed into a host computer or can be analyzed in the same computer system where the database and interface resides or on a host computer. For example, the data from one or more of the round counting module, the shoe sensor, the card swipe, card reading module, the shuffler data port sensor, and the bet interfaces can be used to create a report of rounds played per unit of time, the number of players at the table per unit of time, the number of hands played at each round, the maximum bet per player in a given unit of time, the average bet per player in a unit of time, the number of shuffles per unit of time, the number of cards removed from and placed into the shuffler in a unit of time, hand composition and other information considered important to the casino manager.

Because all of the G-Mod's work independently, the casino operator can choose the modules and resulting data that is most important to them for a given environment, and only purchase those modules. For example, one casino might want to reconstruct individual hands, track betting and associate the information with a particular player on a high stakes table, while tracking only rounds and the identification of the employees on low-stakes games.

By using a modular approach to intelligent data collection, only the equipment and reports that are wanted can be provided at the lowest possible cost. Since none of the G-Mod's are issuing direct commands to one-another, it is not necessary to rewrite any code when additional modules are added.

Applicants have discovered that there are potential inaccuracies in data that is transmitted prior to date/time stamping. When signals are stamped in by the main computer, this is merely indicative of when the signal arrived. Also by providing the stamping function at the receipt site (such as the main processor, or central gaming location), the information is more easily subject to manipulation or change by an operator. Also, when there is a line breakdown (e.g., some casinos may still use telephone line connections which can be busy or interrupted, or the communication system to the main computer breaks down), the accuracy of the stamping is adversely affected. The value of the data decreases in some necessary transactions and casino oversight if the time data is inaccurate. A gaming system with different architectural structure and informational structure would be desirable if it could reduce these issues.

There are many different elements of the gaming system that can be considered as peripherals. Some more important examples of table-game related peripherals include: bet presence, bet recognition, bet separation, card identification, card tracking, player tracking and employee tracking. Another listing of these components would include (in addition to those described above) are multimedia processing, stepper motor control, random number generation, card reading, hand reading (ranking), player strategy review/analysis, I/O detection and response, audio signals, video signals, currency handling, coin acceptors, bill acceptors, paperless transactions, ticket-in and ticket-out crediting, security systems, player accounting functions, door locks, player input (e.g., button controls, joy sticks, touch screens, service calls, etc.) and any other functions that my be provided on the table gaming apparatus.

As noted earlier, round counting is one service or data component that can be important to a table. For example, round completion can be important for evaluating rates of play at tables, player rate performance, dealer rate performance, and even disputes over time of completion of hands at different tables or different casinos where priority might be an issue (as in competitive events or qualifying events).

Round counting requires some form of signal generation at a table that is indicative of approximate completion of a round and preferably absolute completion of a round. This can be done in a number of ways for signal generation. For example, video cameras can be placed to observe the dealer's hand. When the motions of a dealer or the dealer's cards indicate that the dealer's cards have been removed from the playing area, a signal is sent “round completed” or “dealer's hand removed” or some functional equivalent. A sensor can be placed on the table over which the dealer's cards are placed. It is preferred that this sensor not be as movement limiting as the sensor in U.S. Pat. No. 5,803,808, where cards appear to have to be specifically fitted into at least a right angle abutment with a card reading ability. Upright extensions on the card table can interfere with card movement, can interfere with chip movement, can cause accidental disclosure of cards, and are generally undesirable. A sensing system with a relatively flat or slightly indented or slightly raised surface is more desirable. The system could comprise a transparent or translucent panel approximately flush with the table surface that allows light (e.g., ambient light or specially directed wavelengths of light for which a sensor is particularly sensitive) to pass to a sensor. The absence of light in the sensor for a predetermined period of time and/or intervals of time can be the original signals themselves, which are interpreted by an intermediary intelligence on the table that has the time sensing capability for evaluating the signal. The original signals are then time stamped before being forwarded to the central database and can be analyzed by accessing the collected data.

Particularly in games where batch shuffling is used, such as poker or even single deck blackjack, the signal could also be originated by cards being placed in a shuffler and a shuffling process initiated, the shuffler sending a start-shuffling signal to the date stamping component on the table. The dealer could even activate or press a button provided on the table, but this would tend to leave the results under the control of the dealer, which could be manipulated by the dealer to improve results on dealer play, or could suffer from forgetfulness.

The application of this technology to gaming tables follows similar architecture and application of design and performance. Gaming tables would include typical casino tables such as those used for blackjack (Twenty-One), baccarat, roulette, poker, poker variants (Let It Ride® poker, Three-Card Poker® game, Caribbean Stud® poker, etc.), craps, and the like. These latter systems, unless they are completely electronic without any physical implementation (such as physical playing cards, dice, spinning wheel, drop ball, etc.) will need sensing and/or reading equipment (e.g., card reading for suits and/or rank, bet reading sensors, ball position sensors, dice reading sensors, player card readers, dealer input sensors, player input systems, and the like. These would be the peripherals in the table systems. Also, newer capabilities are enabled such as moisture detection (e.g., for spilled drinks), smoke detection, infrared ink detection (to avoid card marking), shuffler operation, dealer shoe operation, discard rack operation, jackpot meters, side bet detectors, and the like.

1. A casino table card gaming system comprising:
at least one gaming table;
at least one sensing device on or proximate to the gaming table, the device sensing activity on the gaming table, and
wherein an intelligent data collection module senses changes in output from the at least one sensing device, the intelligent module acting as a finite state machine capable of date stamping the data and transmitting the date stamped data to a database over a network.

2. The system of claim 1 wherein the sensing device is a light sensor.

3. The system of claim 1 wherein the sensing device is a camera.

4. The system of claim 1 wherein the sensing device is a scanner.

5. The system of claim 1 wherein the sensing device is a RFID circuit.

6. The system of claim 1 wherein the sensing device is a bar code reader.

7. The system of claim 1 wherein the sensing device is selected from the group consisting of: a scene digitizer, a laser scanner and a magnetic strip reader.

8. The system of claim 1 wherein the intelligent data collection module comprises a chipboard.

9. The system of claim 1 wherein the data collection module does not store signals or data contained in the signals after date stamping and forwarding the signals.

10. The system of claim 2 wherein the intelligent data collection module does not store signals.

11. The system of claim 8 wherein the intelligent data collection module does not store signals.

12. The system of claim 2 wherein the sensor detects ambient light.

13. The system of claim 1 wherein date stamped signals are received by a central database that organizes data relating to counting of rounds and a rate of rounds for at least one of a table and a dealer.

14. The system of claim 1 wherein the collected data is transmitted via an Ethernet.

15. The system of claim 1 wherein the network communication method is selected from the group comprising UDP and TCP.

16. The system of claim 1, wherein the sensing device is capable of sensing at least one of: cards dealt, hands dealt, rounds played, amounts wagered, the presence of a wager, the identity of a player, the identity of pit personnel, cards returned to a discard rack, cards returned to a shuffler.

17. A method of collecting data on a casino gaming table, comprising the steps of:
providing at least one sensor for sensing activity on the casino gaming table;
providing at least one intelligent controller dedicated to collecting information from one or more sensors;
the intelligent controller receiving a signal from the at least one sensor;
the intelligent controller date and/or time stamping data collected from the at least one sensor;
the intelligent controller broadcasting the date and/or time stamped data over a network; and
recording the broadcasted information in a database.

18. The method of claim 176 wherein the database receives date stamped signals over a period of time and the data is used by an external processor to compute a number of rounds played over a period of time, the time being based upon use of the date stamping received.

19. The method of claim 17 wherein the original signal from the sensor contains no indication of date or time thereon.

20. The method of claim 17 wherein the signal is provided by an ambient light detector indicating relative amounts of light detected.

21. The method of claim 20 wherein the relative amount of light relates to light blockage or light availability to the detector.

22. A hardware component on a casino card table that senses signals from a hardware component that senses activity on a gaming table, wherein the hardware component adds time and or date stamps information to the signals, and forwards the time stamped signal to a database, via a network.

23. The component of claim 22 wherein the component is constructed so that it cannot store time stamped signals after forwarding the time stamped signals.
